(19) United States
(12) Patent Application Publication
(10) Pub. No.: US 2023/0169373 A1
(43) Pub. Date: Jun. 1, 2023

(54) Predicting a Behavior of a Road User

(71) Applicant: Bayerische Motoren Werke Aktiengesellschaft, Muenchen (DE)

(72) Inventors: Bastian BROECKER, Neufahrn bei Freising (DE); Kai EHRENSPERGER, Dachau (DE); Wilhelm HUBER, Erding (DE); Michael KARG, Kranzberg (DE); Tobias REHDER, Muenchen (DE)

(21) Appl. No.: 17/920,991

(22) PCT Filed: Apr. 8, 2021
(86) PCT No.: PCT/EP2021/059159

§ 371 Date: Oct. 24, 2022

(30) Foreign Application Priority Data
May 18, 2020 (DE) 10 2020 113 338.3

(51) Int. Cl. G06N 7/01; G06Q 50/30; G06Q 10/04; G08G 1/01; B60W 50/00

(52) U.S. Cl. CPC G06N 7/01; G06Q 50/30; G06Q 10/04; G08G 1/0112; G08G 1/0125; B60W 50/0097; B60W 2554/4046

(57) ABSTRACT

A device and method predict a behavior of a road user. The device is configured to provide at least one hypothesis for the behavior of the road user, to provide, for each hypothesis, a hidden Markov model, the hidden Markov model including, for the particular hypothesis, two hidden states, with one of these hidden states representing the road user following the hypothesis and the other of these states representing the road user not following the hypothesis, and possible observations of the hidden Markov model characterizing, for the particular hypothesis, at least one feature of the road user, and to predict the behavior of the road user depending on the hidden states of the hidden Markov model for the at least one hypothesis.

### BACKGROUND AND SUMMARY

The invention relates to a device and a method for predicting a behavior of a road user.

Within the scope of this document, the term “automated driving” may be understood to mean driving with automated longitudinal or lateral guidance, or autonomous driving with automated longitudinal and lateral guidance. The term “automated driving” encompasses automated driving with any degree of automation. Exemplary degrees of automation are assisted, partially automated, highly automated or fully automated driving. These degrees of automation have been defined by the Bundesanstalt für Straßenwesen (BASt—German Federal Highway Research Institute) (see BASt publication Forschung kompakt, Issue November 2012). In the case of assisted driving, the driver performs the longitudinal or lateral guidance permanently, while the system takes over the respective other function within certain limits. In the case of partially automated driving, the system takes over the longitudinal and lateral guidance for a certain period of time and/or in specific situations, whereby the driver has to monitor the system permanently, as in the case of assisted driving. In the case of highly automated driving, the system takes over the longitudinal and lateral guidance for a certain period of time, without the driver having to monitor the system permanently; but the driver has to be capable of taking over the guidance of the vehicle within a certain time. In the case of fully automated driving, the system can manage the driving in all situations automatically for a specific application; no driver is required any longer for this application. The aforementioned four degrees of automation according to the definition given by the BASt correspond to SAE Levels 1 to 4 of the SAE J3016 standard (SAE—Society of Automotive Engineering). For instance, highly automated driving according to the BASt corresponds to Level 3 of the SAE J3016 standard. Furthermore, SAE Level 5 is also provided in SAE J3016 as the highest degree of automation, which is not included in the definition given by the BASt. SAE Level 5 corresponds to driverless driving, in which the system can cope with all situations automatically like a human driver during the entire journey; a driver is generally no longer required.

In order to be able to realize automated driving in a qualitatively sophisticated manner, it is necessary to predict the behavior of road users in the environment of the automated vehicle.

Many approaches are already known for this purpose, which, for instance, operate with artificial intelligence and, in particular, with neural networks. However, these approaches are usually associated with a conflict of objectives between a prediction of the behavior of the road users that is as exact as possible and resource requirements that are as low as possible for the ascertainment of the result of the prediction.

The object of the invention is to provide a device and a method for predicting the behavior of a road user with high quality and with low resource requirement.

The object is achieved by the features of the independent claims. Advantageous embodiments are described in the dependent claims. Attention is drawn to the fact that additional features of a claim that is dependent on an independent claim without the features of the independent claim, or only in combination with a subset of the features of the independent claim, may constitute a separate invention that is independent of the combination of all the features of the independent claim and that may be made the subject-matter of an independent claim, of a divisional application or of a subsequent application. This applies equally to technical teachings described in the description, which may constitute an invention that is independent of the features of the independent claims.

A first aspect of the invention relates to a device for predicting a behavior of a road user, in particular of a motor vehicle by way of road user.

In particular, the device for predicting the behavior of the road user is an integral part of a driver-assistance system or of a driving system of an automated motor vehicle, and provides the predicted behavior of the road user to the driver-assistance system or driving system by way of information for motion planning and motion control.

The behavior of the road user encompasses, in particular, at least one decision of the road user in the course of achieving its driving task, such as, for instance, a decision of the road user to follow a traffic lane or to leave the traffic lane.

The device has been set up to provide at least one hypothesis for the behavior of the road user. In this connection, a hypothesis describes precisely one possible behavior of the road user. In other words, a hypothesis establishes, for a limited time-horizon, a scenario as regards the decisions that the road user will take in the course of managing the driving task.

In addition, the device has been set up to provide a hidden Markov model for each hypothesis.

The hidden Markov model comprises precisely two hidden states for the respective hypothesis, one of these hidden states representing compliance with the hypothesis by the road user, and the other one of these states representing non-compliance with the hypothesis by the road user.

In this connection, the insight underlying the invention is that the algorithmic complexity of the hidden Markov model remains limited by the restriction to precisely two hidden states, since this complexity usually increases quadratically with the number of all states.

The two hidden states for the respective hypothesis describe the logically opposed possibilities and are therefore complete with respect to the actual action options of the road user. Either the road user complies with the hypothesis, or the road user does not comply with the hypothesis. Consequently, at any time the road user is in one of the two states.

The possible observations of the hidden Markov model for the respective hypothesis characterize at least one feature of the road user. In particular, a relationship in the form of a probability-density function exists between the manifestation of the at least one feature and a hidden state, so that each manifestation of the feature stands for a certain probability that the respective hidden state currently obtains.

The at least one feature is, in particular, an absolute feature of the road user, the manifestation of which can be ascertained solely by examination of the road user.

Alternatively, the at least one feature is, in particular, a relative feature of the road user, the manifestation of which can only be ascertained by examination of the road user in relation to a reference object—for instance in relation to a traffic lane, a further road user or an ego vehicle.

The device has been set up to predict the behavior of the road user as a function of the hidden states of the hidden Markov model for the at least one hypothesis.

The prediction of the behavior of the road user is undertaken, in particular, by ascertainment of the most probable hidden state of the hidden Markov model for the at least one hypothesis for the behavior of the road user.

The prediction of the behavior of the road user may comprise, for instance, the formulating of the at least one hypothesis and the ascertaining of the most probable hidden state of the hidden Markov model. Alternatively, the prediction of the behavior of the road user may also comprise only the ascertaining of the most probable hidden state of the hidden Markov model.

By virtue of the ascertainment of the most probable hidden state of the hidden Markov model, for each hypothesis it is ascertained whether the road user is complying with the hypothesis—that is to say, whether the behavior of the road user corresponds to the hypothesis.

In the case of several hypotheses, and consequently several hidden Markov models, it is possible that the most probable state of several hidden Markov models corresponds to compliance with the respective hypothesis by the road user. In this case—or in the opposite case, where a most probable state cannot be ascertained unambiguously for any hidden Markov model—the behavior of the road user may be deemed to be non-classifiable, which in the case of a driver-assistance system might lead, for instance, to an increase of the safe distance from the respective road user.

In an advantageous embodiment, the at least one feature of the road user is a quantifiable feature of the road user. A feature is quantifiable, in particular, if its manifestation can be reformulated into measurable quantities and numerical values. For instance, a feature is quantifiable if its manifestation can be represented by a numerical value without thereby substantially losing information content, or even without losing information content. Consequently, a trajectory of the road user, for instance, is just not a quantifiable feature.

In another advantageous embodiment, the possible observations of the hidden Markov model for the respective hypothesis characterize at least two mutually independent features. Features are independent, in particular, when the probability with which the manifestation of the feature permits a hidden state to be inferred is independent of the manifestation of the other feature.

For instance, it can be assumed that in the case of a road user turning off to the right at an intersection the distance of the road user from the center of the lane is independent of the angular distance of the orientation of the lane. This assumption may possibly not always actually be correct at all, though the complexity of the model is greatly restricted thereby.

In another advantageous embodiment, the possible observations of the hidden Markov model for the respective hypothesis include, by way of feature, a distance of the road user from a center of a traffic lane in which the road user is located.

In this connection, the insight underlying the invention is that the distance of the road user from the center of the traffic lane in which the road user is located is very determinative of certain behaviors of the road user. From the distance of the road user from the center of the traffic lane in which the road user is located, information can accordingly be obtained for hypotheses such as, for instance, that the road user is following the traffic lane or turning off from the traffic lane.

In another advantageous embodiment, the possible observations of the hidden Markov model for the respective hypothesis include, by way of feature, a deviation of an orientation of the road user relative to an orientation of a traffic lane in which the road user is located.

In this connection, the insight underlying the invention is that the deviation of the orientation of the road user relative to the orientation of the traffic lane in which the road user is located is likewise very determinative of certain behaviors of the road user. From the deviation of the orientation of the road user relative to the orientation of the traffic lane in which the road user is located, information can accordingly be obtained for hypotheses such as, for instance, that the road user is following the traffic lane or turning off from the traffic lane.

The orientation of the road user and the orientation of the traffic lane are, in particular, yaw angles, the difference of which indicates a deviation.

In another advantageous embodiment, the possible observations of the hidden Markov model for the respective hypothesis include, by way of feature, an activation of a travel-direction indicator of the road user.

In this connection, the insight underlying the invention is that the activation of a travel-direction indicator is also very determinative of certain behaviors of the road user. From the activation of a travel-direction indicator, information can accordingly be obtained for hypotheses such as, for instance, that the road user is turning off from the traffic lane to the left or to the right.

Moreover, the underlying modeling makes it possible to take account of the fact that road users indicating, for example, to the right will, with a low probability, not turn off to the right after all, or that a road user will turn off without indicating.

In another advantageous embodiment, the possible observations of the hidden Markov model for the respective hypothesis include a feature that is characteristic of a yielding behavior of the road user. A feature that is characteristic of a yielding behavior of the road user is, for instance, a deceleration of the road user, in particular when the road user has to yield by reason of the priority situation obtaining.

With a view to simplifying the model, the named features are assumed to be independent of one another to a limited extent, given the hidden state, for which reason the named features are suitable, in particular, for combination in a hidden Markov model.

In another advantageous embodiment, the device has been set up to ascertain a traffic situation in which the road user is located, and to ascertain the at least one hypothesis for the behavior of the road user as a function of this traffic situation.

A second aspect of the invention relates to a method for predicting a behavior of a road user.

One step of the method is the provision of at least one hypothesis for the behavior of the road user.

A further step of the method is the provision of a hidden Markov model for each hypothesis, the hidden Markov model for the respective hypothesis comprising two hidden states, one of these hidden states representing compliance with the hypothesis by the road user, and the other one of these states representing non-compliance with the hypothesis by the road user, and the possible observations of the hidden Markov model for the respective hypothesis characterizing at least one feature of the road user.

A further step of the method is the predicting of the behavior of the road user as a function of the hidden states of the hidden Markov model for the at least one hypothesis.

The foregoing statements relating to the device according to the invention as defined by the first aspect of the invention apply in corresponding manner also to the method according to the invention as defined by the second aspect of the invention. Advantageous exemplary embodiments of the method according to the invention not described explicitly at this point and in the claims correspond to the advantageous exemplary embodiments of the device according to the invention described above or described in the claims.

The invention will be described below with reference to an exemplary embodiment with the aid of the appended drawings.

### BRIEF DESCRIPTION OF THE DRAWINGS

FIG. 1 shows an exemplary traffic situation;

FIG. 2 shows an exemplary embodiment of the device according to the invention; and

FIG. 3 shows a further exemplary embodiment of the device according to the invention.

### DETAILED DESCRIPTION OF THE DRAWINGS

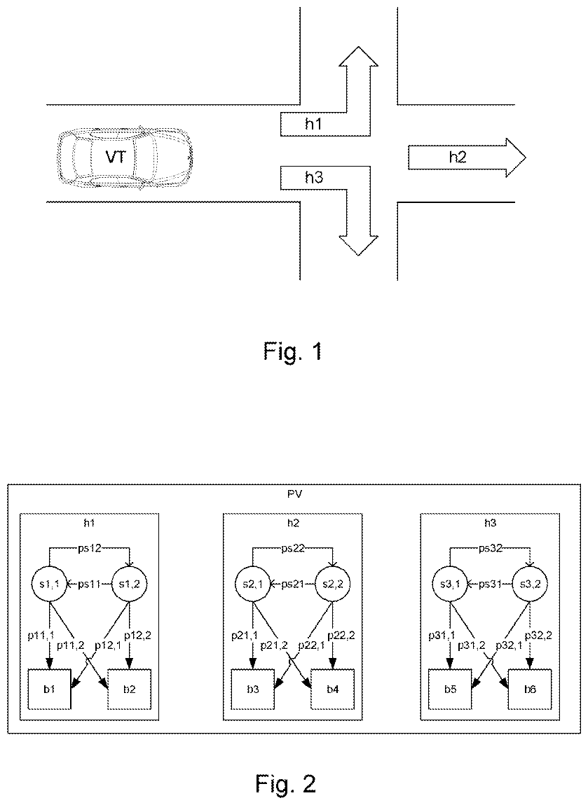

FIG. 1 shows an exemplary traffic situation. In this traffic situation, a road user VT is moving toward an intersection at which it has three different behavior options. It can turn off to the left, drive straight through the intersection, or turn off to the right.

A first hypothesis h1 for the behavior of the road user VT is that the road user VT will turn off to the left.

A second hypothesis h2 for the behavior of the road user VT is that the road user VT will drive straight through the intersection.

A third hypothesis h3 for the behavior of the road user VT is that the road user VT will turn off to the right.

FIG. 2 shows an exemplary embodiment of the device PV according to the invention for predicting a behavior of a road user VT.

The device PV has been set up to provide at least one hypothesis h1, h2, h3 for the behavior of the road user VT. For this purpose, the device PV has been set up, in particular, to ascertain a traffic situation in which the road user VT is located, and to ascertain the at least one hypothesis h1, h2, h3 for the behavior of the road user VT as a function of this traffic situation. If, for instance, the road user VT is moving toward an intersection, as shown in FIG. 1, the traffic lanes leading away from the intersection may serve as hypotheses h1, h2, h3.

In addition, the device PV has been set up to provide a hidden Markov model for each hypothesis h1, h2, h3.

The hidden Markov model comprises two hidden states s1,1-s3,2 for the respective hypothesis—that is to say, hidden states s1,1 and s1,2 for hypothesis h1, hidden states s2,1 and s2,2 for hypothesis h2, and hidden states s3,1 and s3,2 for hypothesis h3.

In each instance, one of these hidden states—namely, for instance, hidden states s1,1, s2,1 and s3,1—represents compliance with the respective hypothesis h1, h2, h3 by the road user VT.

The respective other one of these states—that is to say, states s1,2, s2,2 and s3,2—represents non-compliance with the respective hypothesis h1, h2, h3 by the road user VT.

Each hidden Markov model includes a predetermined probability of switching between its two states. Accordingly, the hidden Markov model for hypothesis h1, for instance, switches from state s1,1 to state s1,2 with probability ps12, and from state s1,2 to state s1,1 with probability psi 1. The hidden Markov model for hypothesis h2, for instance, switches from state s2,1 to state s2,2 with probability ps22, and from state s2,2 to state s2,1 with probability ps21. The hidden Markov model for hypothesis h3, for instance, switches from state s3,1 to state s3,2 with probability ps32, and from state s3,2 to state s3,1 with probability ps31.

These probabilities are each 50%, for instance.

The respective hidden Markov models include, in addition, possible observations b1-b6. The possible observations b1-b6 characterize at least one feature of the road user VT, in particular a quantifiable feature of the road user VT.

The possible observations b1-b6 of the hidden Markov models for hypotheses h1, h2, h3 characterize at least two feature groups m1, m2 modeled independently of one another to a limited extent.

For instance, the possible observations b1, b2 of the hidden Markov model for hypothesis h1 characterize a distance of the road user VT from a center of a traffic lane in which the road user VT is located. In addition, the possible observations b3, b4 of the hidden Markov model for hypothesis h2 characterize, for instance, a deviation of an orientation of the road user VT relative to an orientation of a traffic lane in which the road user VT is located.

For each hidden state s1,1-s3,2 there is a certain probability p11,1-p32,2 that the respective possible observation b1-b6 is actually observed.

The device PV has, in addition, been set up to predict the behavior of the road user VT as a function of the hidden states s1,1-s3,2 of the hidden Markov model for the at least one hypothesis h1, h2, h3.

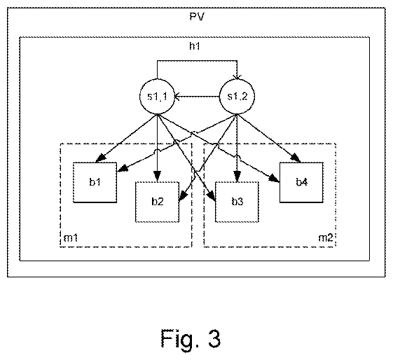

FIG. 3 shows a further exemplary embodiment of the device PV according to the invention for predicting a behavior of a road user VT.

The device PV has been set up to provide at least one hypothesis h1 for the behavior of the road user VT, and to provide a hidden Markov model for this hypothesis h1.

The hidden Markov model comprises two hidden states s1,1; s1,2 for hypothesis h1, one of these hidden states s1,1 representing compliance with hypothesis h1 by the road user VT, and the other one of these states s1,2 representing non-compliance with hypothesis h1 by the road user VT.

The possible observations b1-b4 of the hidden Markov model for hypothesis h1 characterize at least one feature of the road user VT. In this case, the possible observations b1-b4 of the hidden Markov model for hypothesis h1 characterize two mutually independent feature groups m1, m2, feature group m1 comprising observations b1 and b2, and feature group m2 comprising observations b3 and b4.

For instance, possible observations b1 and b2 of the hidden Markov model for hypothesis h1 characterize an activation of a travel-direction indicator of the road user VT, and possible observations b3 and b4 of the hidden Markov model for hypothesis h1 characterize a feature that is characteristic of a yielding behavior of the road user VT.

Alternatively, b1 characterizes a distance from the center line, b2 characterizes a difference of orientation relative to the lane, b3 characterizes a turn-indicator state in the current time-step, and b4 characterizes a priority feature which is computed, for instance, from at least one traffic rule and an acceleration behavior or deceleration behavior.

For the sake of clarity, in FIG. 3—in comparison with FIG. 2—no probabilities have been represented for transition between the hidden states s1,1 and s1,2, and also no probabilities for the possible observations b1-b4 in the hidden states s1,1 and s1,2.

The device PV has been set up to predict the behavior of the road user VT as a function of the hidden states s1,1 and s1,2 of the hidden Markov model for hypothesis h1.

1.-9. (canceled)

10. A device, comprising:
a computer-implemented device that predicts a behavior of a road user, the device being operatively configured to:
provide at least one hypothesis for the behavior of the road user,
provide a hidden Markov model for each hypothesis, the hidden Markov model for a respective hypothesis comprising two hidden states, one of said two hidden states representing compliance with the hypothesis by the road user, and the other one of said two hidden states representing non-compliance with the hypothesis by the road user, and comprising possible observations of the hidden Markov model for the respective hypothesis characterizing at least one feature of the road user, and
predict the behavior of the road user as a function of the two hidden states of the hidden Markov model for the at least one hypothesis.

11. The device according to claim 10, wherein
the at least one feature of the road user is a quantifiable feature of the road user.

12. The device according to claim 10, wherein
the possible observations of the hidden Markov model for the respective hypothesis characterize at least two mutually independent feature groups.

13. The device according to claim 10, wherein
the possible observations of the hidden Markov model for the respective hypothesis include, by way of a feature, a distance of the road user from a center of a traffic lane in which the road user is located.

14. The device according to claim 10, wherein
the possible observations of the hidden Markov model for the respective hypothesis include, by way of a feature, a deviation of an orientation of the road user relative to an orientation of a traffic lane in which the road user is located.

15. The device according to claim 10, wherein
the possible observations of the hidden Markov model for the respective hypothesis include, by way of a feature, an activation of a travel-direction indicator of the road user.

16. The device according to claim 10, wherein
the possible observations of the hidden Markov model for the respective hypothesis include a feature that is characteristic of a yielding behavior of the road user.

17. The device according to claim 10, wherein the device is further operatively configured to:
ascertain a traffic situation in which the road user is located, and
ascertain the at least one hypothesis for the behavior of the road user as a function of this traffic situation.

18. A method for predicting a behavior of a road user, the method comprising the steps of:
providing at least one hypothesis for the behavior of the road user;
providing a hidden Markov model for each hypothesis, the hidden Markov model for the respective hypothesis comprising two hidden states, one of said two hidden states representing compliance with the hypothesis by the road user, and the other one of said two hidden states representing non-compliance with the hypothesis by the road user, and comprising possible observations of the hidden Markov model for the respective hypothesis characterizing at least one feature of the road user; and
predicting the behavior of the road user as a function of the hidden states of the hidden Markov model for the at least one hypothesis.

19. The method according to claim 18, wherein
the at least one feature of the road user is a quantifiable feature of the road user.

20. The method according to claim 18, wherein
the possible observations of the hidden Markov model for the respective hypothesis characterize at least two mutually independent feature groups.

21. The method according to claim 18, wherein
the possible observations of the hidden Markov model for the respective hypothesis include, by way of a feature, a distance of the road user from a center of a traffic lane in which the road user is located.

22. The method according to claim 18, wherein
the possible observations of the hidden Markov model for the respective hypothesis include, by way of a feature, a deviation of an orientation of the road user relative to an orientation of a traffic lane in which the road user is located.

23. The method according to claim 18, wherein
the possible observations of the hidden Markov model for the respective hypothesis include, by way of a feature, an activation of a travel-direction indicator of the road user.

24. The method according to claim 18, wherein
the possible observations of the hidden Markov model for the respective hypothesis include a feature that is characteristic of a yielding behavior of the road user.

25. The method according to claim 18, wherein the method further comprises the steps of:
ascertaining a traffic situation in which the road user is located, and
ascertaining the at least one hypothesis for the behavior of the road user as a function of this traffic situation.
